(19) United States
(12) Patent Application Publication
(10) Pub. No.: US 2025/0350665 A1
(43) Pub. Date: Nov. 13, 2025

(54) Cross-Device Data Transfer Based On A Request-Responding Mode

(71) Applicant: Microsoft Technology Licensing, LLC, Redmond, WA (US)

(72) Inventors: Libin SHI, Beijing (CN); Bin FANG, Beijing (CN); Min WAN, Beijing (CN); Peng CHEN, Beijing (CN); Jing ZENG, Beijing (CN); Hui GUO, Suzhou (CN); Jiyan LU, Suzhou (CN); Chang SU, Suzhou (CN)

(21) Appl. No.: 19/103,533

(22) PCT Filed: Sep. 15, 2023
(86) PCT No.: PCT/US2023/032818

§ 371 Date: Feb. 12, 2025

(30) Foreign Application Priority Data
Oct. 28, 2022 (CN) 202211334801.2

(51) Int. Cl. H04L 67/56; H04L 67/02

(52) U.S. Cl. CPC H04L 67/56; H04L 67/02

(57) ABSTRACT

The present disclosure provides methods, systems and apparatus for cross-device data transfer. The cross-device data transfer is based on request-responding mode. The target application in a first terminal device may identify a trigger operation indicating to obtain target data in a second terminal device and generate a data request including a resource describing statement corresponding to the target data. A cross-device data transfer network unit may generate a data command based on the resource describing statement in the data request and send the data command to a device client in the second terminal device. The device client may obtain the target data based on the data command and send a command response including the target data to the cross-device data transfer network unit. The cross-device data transfer network unit may send a request response including the target data to the target application.

### BACKGROUND

A user with multiple terminal devices may desire to obtain an efficient cross-device experience, e.g., cross-device data transfer among different terminal devices. The purpose of cross-device data transfer is to enable a user to obtain, at least on one terminal device, data stored in another terminal device. For example, assuming that a user has a desktop computer and a smartphone, the user may desire or need to access, in the desktop computer, data (such as photos) in the smartphone, in order to process, in the desktop computer, the data in the smartphone. In this case, cross-device data transfer from the smartphone to the desktop computer is required.

### SUMMARY

This Summary is provided to introduce a selection of concepts that are further described below in the Detailed Description. It is not intended to identify key features or essential features of the claimed subject matter, nor is it intended to be used to limit the scope of the claimed subject matter. Embodiments of the present disclosure propose methods, systems and apparatus for cross-device data transfer. The cross-device data transfer is based on a request-responding mode. The target application in a first terminal device may identify a trigger operation indicating to obtain target data in a second terminal device and generate a data request including a resource describing statement corresponding to the target data. A cross-device data transfer network unit may generate a data command based on the resource describing statement in the data request, and send the data command to a device client in the second terminal device. The device client in the second terminal device may obtain the target data based on the data command, and send a command response to the cross-device data transfer network unit, the command response including the target data. The cross-device data transfer network unit may send a request response to the target application in the first terminal device, the request response including the target data.

It should be noted that the above one or more aspects comprise the features hereinafter fully described and particularly pointed out in the claims. The following description and the drawings set forth in detail certain illustrative features of the one or more aspects. These features are only indicative of the various ways in which the principles of various aspects may be implemented, and this disclosure is intended to include all such aspects and their equivalents.

### BRIEF DESCRIPTION OF THE DRAWINGS

The disclosed aspects will hereinafter be described in conjunction with the appended drawings that are provided to illustrate and not to limit the disclosed aspects.

FIG. 1A and FIG. 1B illustrate an exemplary architecture for cross-device data transfer according to an embodiment.

FIG. 2 illustrates an exemplary process of cross-device data transfer according to an embodiment.

FIG. 3 illustrates an exemplary process of cross-device data transfer according to an embodiment.

FIG. 4A, FIG. 4B, FIG. 4C, FIG. 4D and FIG. 4E illustrate an exemplary application scenario according to an embodiment.

FIG. 5A, FIG. 5B, FIG. 5C and FIG. 5D illustrate an exemplary application scenario according to an embodiment.

FIG. 6, FIG. 7 and FIG. 8 illustrate a flowchart of an exemplary method for cross-device data transfer according to an embodiment.

FIG. 9, FIG. 10 and FIG. 11 illustrate an exemplary apparatus for cross-device data transfer according to an embodiment.

FIG. 12 illustrates an exemplary apparatus for cross-device data transfer according to an embodiment.

### DETAILED DESCRIPTION

The present disclosure will now be discussed with reference to several exemplary implementations. It is to be understood that these implementations are discussed only for enabling those skilled in the art to better understand and thus implement the embodiments of the present disclosure, rather than suggesting any limitations on the scope of the present disclosure. There are some existing cross-device data transfer mechanisms. In the cross-device data transfer mechanism based on cloud, multiple terminal devices of a user may serve as multiple clients respectively, and each client pushes or synchronizes its data to the cloud storage unit. Each client may then pull updated data from the cloud storage unit, the updated data including at least data from other clients. Each client may communicate with the cloud storage unit through e.g., a http connection. The cross-device data transfer mechanism based on cloud requires the multiple clients to use the same cloud storage account, which will limit the use of cross-device data transfer since these clients may not have the same cloud storage account. Cloud storage services are usually not free, because users need to synchronize a large amount of data in their multiple terminal devices to the cloud storage unit, which will result in a large storage overhead. Additionally, it is possible that only a small portion of the large amount of data in the cloud storage unit may be actually used by the user, which will lead to the waste of unnecessary transport, storage and overhead. The cross-device data transfer mechanism based on cloud needs to store personal information and a large amount of personal data of the user in the cloud storage unit, which will bring the risk of data leakage. In the cross-device data transfer mechanism based on WebSocket connection, multiple terminal devices communicate with the WebSocket server through WebSocket connections, respectively, so that one terminal device may obtain data in another terminal device through the WebSocket connection. In a cross-device data transfer mechanism based on a peer-to-peer (P2P) connection, multiple terminal devices may be directly connected to each other through, e.g., a real-time communication (RTC) technology, in order to exchange data. However, both the cross-device data transfer mechanism based on WebSocket connection and the cross-device data transfer mechanism based on P2P connection require the terminal device to be integrated with a specific Software Development Kit (SDK) to implement data transfer, which will significantly increase the difficulty and feasibility of integration.

Embodiments of the present disclosure propose a cross-device data transfer mechanism based on a request-responding mode, so as to implement on-demand fetching cross-device experience. For a first terminal device and a second terminal device among multiple terminal devices of a user, an embodiment of the present disclosure enables to implement data transfer from the second terminal device to the first terminal device in a request-responding manner, so that the first terminal device may obtain the target data in the second terminal device. Herein, the target data may broadly include various resources stored in the terminal device and information, such as metadata, associated with the resources, etc. A resource may broadly refer to various data stored in the terminal device, e.g., files, messages, contact information, location information, etc. A file may include various types of file such as text file, image file, audio file, video file, etc., a message may include various types of message such as social media application message, mobile phone text message, etc., contact information may include various types of contact-related information such as phone number, email address, etc., and location information may include information describing location such as geographic coordinates, geographic names, etc.

According to an embodiment of the present disclosure, only when it requires specific target data stored in a second terminal device to be obtained in a first terminal device, the target data is transferred from the second terminal device to the first terminal device. For example, when it requires target data in the second terminal device to be obtained in the first terminal device, the first terminal device may request the target data from the second terminal device, and the second terminal device may transfer the target data to the first terminal device in response to the request. Through such a request-responding mode, the second terminal device may only transfer desired target data to the first terminal device without pushing, synchronizing or transferring other data stored in the second terminal device. Embodiments of the present disclosure propose to deploy a cross-device data transfer network unit, a WebSocket server, etc., on the network side, to implement the cross-device data transfer based on the request-responding mode. Embodiments of the present disclosure do not need to use a cloud storage unit on the network side, thereby avoiding data push or synchronization from a terminal device to a cloud storage unit as required by existing cross-device data transfer mechanisms based on cloud. Accordingly, embodiments of the present disclosure may effectively save transport resources, storage resources, overhead, etc. Embodiments of the present disclosure may perform cross-device data transfer in real time without storing personal information and a large amount of personal data on the network side as done with existing cross-device data transfer mechanisms based on cloud, thereby effectively reducing the risk of data leakage. Additionally, since no cloud storage service is used, embodiments of the present disclosure do not require the use of a cloud storage account.

According to an embodiment of the present disclosure, in one case, the target data may only be a designated part of a designated resource in the second terminal device. Accordingly, it is possible that only the designated part of the designated resource is transferred from the second terminal device to the first terminal device, without transferring the entire designated resource. For example, assuming that the designated resource is a video file, and the designated part is a segment in the video file, when only the specific segment in the video file is expected to be obtained in the first terminal device, it is possible that only the specific segment is transferred from the second terminal device to the first terminal device without transferring the entire video file. In this case, the request-responding mode according to embodiments of the present disclosure may further cover request and response for the designated part of the designated resource. Accordingly, embodiments of the present disclosure may further save transport resources, storage resources, overhead, etc. Additionally, extraction of the designated part of the designated resource may be performed in the second terminal device, which will effectively guarantee data security and avoid data leakage.

According to an embodiment of the present disclosure, a set of resource describing statements may be predefined, and each resource describing statement may be used to describe a path for obtaining of corresponding target data. The first terminal device may request the target data by simply calling the predefined resource describing statement. For example, the resource describing statement may be defined with at least an Application Programming Interface (API), each API may represent corresponding target data. Preferably, a Representation State Transfer (REST) API may be employed to define the resource describing statement. Accordingly, embodiments of the present disclosure do not require presetting a complex client or integrating a specific SDK in the first terminal device. This will make the integration of the mechanism according to the embodiments of the present disclosure to be easier and more feasible, and this integration is simpler for various platforms such as Web, Windows, Android, Mac, etc.

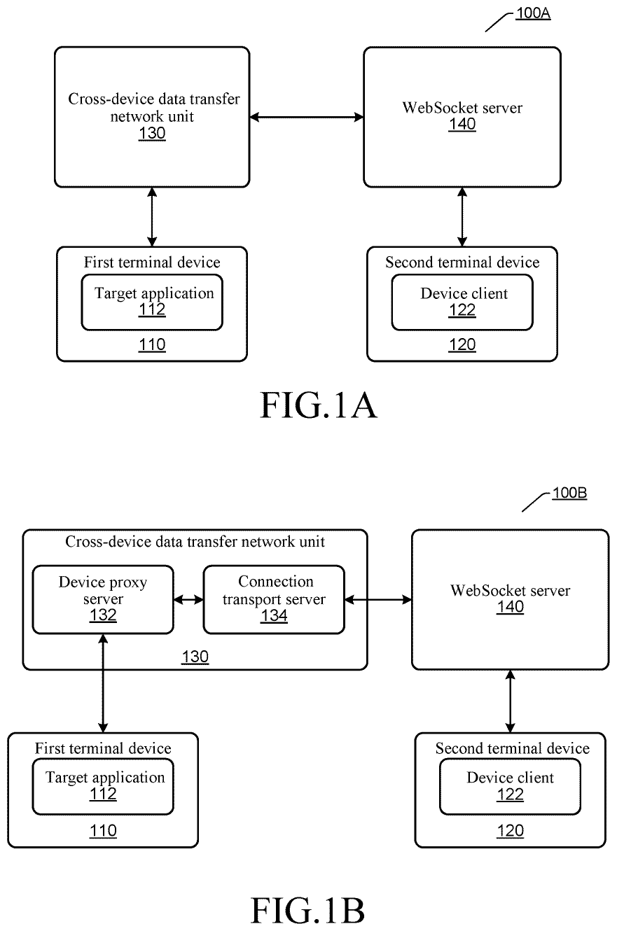

FIG. 1A illustrates an exemplary architecture 100A for cross-device data transfer according to an embodiment. The architecture 100A may be used to implement the cross-device data transfer mechanism based on the request-responding mode according to an embodiment of the present disclosure.

In the architecture 100A, it is assumed that a user wants to obtain, in a first terminal device 110, target data stored in a second terminal device 120. Exemplarily, while the user is using the target application 112 in the first terminal device 110, the user may want to obtain the target data in the second terminal device 120 and to process the target data in the target application 112, e.g., to present the target data, share or send the target data, etc., in the target application 112. Herein, the target application may broadly cover various application programs, software, widgets, processes, tasks, etc., running in the first terminal device 110, e.g., file editor, file browser (explorer), online meeting application, email application, social media application, etc., which is able to use the target data from the second terminal device 120. The target application 112 may include a functional module for implementing processing associated with the cross-device data transfer based on a request-responding mode according to embodiments of the present disclosure. Hereinafter, various processing described involving the target application may be performed by this functional module. The second terminal device 120 may include a device client 122. The device client 122 may be an application or a client installed in the second terminal device 120 for implementing processing associated with the cross-device data transfer based on the request-responding mode according to embodiments of the present disclosure. For example, the device client 122 may be configured to establish a network connection, process received data commands, extract target data, etc. It should be understood that the first terminal device 110 and the second terminal device 120 may be various types of terminal devices, e.g., desktop computer, notebook computer, tablet computer, smart phone, smart TV, smart screen, etc., and embodiments of the present disclosure are not limited to cross-device data transfer from any particular type of second terminal device 120 to any particular type of first terminal device 110.

The architecture 100A may include a cross-device data transfer network unit 130. The cross-device data transfer network unit 130 is configured to manage cross-device data transfer from the second terminal device 120 to the first terminal device 110 according to an embodiment of the present disclosure. In an aspect, the cross-device data transfer network unit 130 may communicate with the target application 112, to receive a data request from the target application 112 for the target data in the second terminal device 120 and send a request response including the target data to the target application 112. The cross-device data transfer network unit 130 and the target application 112 may communicate through, e.g., a http connection. A data request from target application 112 may include a resource describing statement corresponding to the target data. In an implementation, the resource describing statement may be defined at least with an API, e.g., the resource describing statement may be defined with a REST API. The cross-device data transfer network unit 130 may generate a data command based on the resource describing statement. The cross-device data transfer network unit 130 may send the data command to the device client 122 in the second terminal device 120 to request the target data, and receive a command response including the target data from the device client 122.

In an implementation, preferably, the transport of data commands and command responses between the cross-device data transfer network unit 130 and the device client 122 may be implemented through a WebSocket server 140. The WebSocket server 140 is configured to negotiate and establish a WebSocket connection between the cross-device data transfer network unit 130 and the device client 122, and to communicate data commands and command responses between the cross-device data transfer network unit 130 and the device client 122 by using the WebSocket connection. It should be understood that although the architecture 100A employs the WebSocket server 140 to transfer data commands and command responses between the cross-device data transfer network unit 130 and the device client 122, embodiments of the present disclosure are not limited thereto, but may also employ any other suitable way to communicate data commands and command responses between the cross-device data transfer network unit 130 and the device client 122.

FIG. 1B illustrates an exemplary architecture 100B for cross-device data transfer according to an embodiment. The architecture 100B is a further implementation of the architecture 110A in FIG. 1A. In the architecture 100B, a cross-device data transfer network unit 130 may include a device proxy server 132 and a connection transport server 134.

In one aspect, the device proxy server 132 is capable of communicating with a target application 112. For example, the device proxy server 132 may be configured to receive a data request from the target application 112 and send a request response to the target application 112. In one aspect, the device proxy server 132 is capable of generating a data command. For example, the device proxy server 132 may be configured to generate a data command based on a resource describing statement included in the data request. In one aspect, the device proxy server 132 is capable of communicating with the connection transport server 134. For example, the device proxy server 132 may be configured to send the data command to the connection transport server 134 and receive a command response from the connection transport server 134. The device proxy server 132 and the target application 112 may communicate through a http connection, and the device proxy server 132 and the connection transport server 134 may communicate through a http connection.

In one aspect, the connection transport server 134 is capable of communicating with the device proxy server 132. For example, the connection transport server 134 may be configured to receive a data command from the device proxy server 132 and send a command response to the device proxy server 132. In one aspect, the connection transport server 134 may establish a WebSocket connection with a WebSocket server 140 and communicate with the WebSocket server 140. For example, the connection transport server 134 may be configured to send a data command to the WebSocket server 140 and receive a command response from the WebSocket server 140. The connection transport server 134 and the device proxy server 132 may communicate through a http connection, and the connection transport server 134 and the WebSocket server 140 may communicate through a WebSocket connection.

Through the architecture 100B, data layer processing and transport layer processing in the cross-device data transfer network unit 130 may be implemented at the device proxy server 132 and the connection transport server 134, respectively. The device proxy server 132 may operate at least according to a terminal data protocol defined for the second terminal device 122 to perform the data layer processing. For example, the device proxy server 132 may convert the resource describing statement included in the data request into a data command at least according to the terminal data protocol. For example, the device proxy server 132 may, at least according to the terminal data protocol, extract target data from the data stream corresponding to the command response from the connection transport server 134 to further form a request response. Additionally, the terminal data protocol may also be supported by the device client 122 in the second terminal device 120, so that the device client 122 may parse the data command generated by the device proxy server 132 in order to prepare the target data for which the data command is directed. The connection transport server 134 may operate at least according to a transport protocol defined for the second terminal device 122 to perform the transport layer processing, e.g., segmentation, chunking, reordering, etc. For example, the connection transport server 134 may be configured to perform the transport layer processing on a data command and a command response according to the transport protocol.

In an implementation, the device proxy server 132 and the connection transport server 134 may be two separate network entities, e.g., two separate servers. Accordingly, the device proxy server 132 and the connection transport server 134 that are separate from each other may form the cross-device data transfer network unit 130 together. In another implementation, the device proxy server 132 and the connection transport server 134 may be located in a same network entity. Accordingly, the device proxy server 132 and the connection transport server 134 may act as two components in the cross-device data transfer network unit 130 respectively.

In the architecture 100A and the architecture 100B, by means of setting the cross-device data transfer network unit 130, it is possible to avoid directly connecting the first terminal device 110 to the WebSocket server 140, thereby avoiding presetting complicated clients or integrating specific SDKs in the first terminal device. Additionally, by means of using resource describing statements defined by, e.g., API, it is possible to simply and conveniently integrate in the target application 112 a functional module for implementing processing associated with the cross-device data transfer based on the request-responding mode according to embodiments of the present disclosure.

According to the architecture 100A and the architecture 100B, the cross-device data transfer network unit 130 and the WebSocket server 140 on the network side, and the target application 112 and the device client 122 on the terminal side may cooperate to implement the cross-device data transfer based on the request-responding mode according to embodiments of the present disclosure.

It should be understood that the architecture 100A and the architecture 100B exemplarily show systems for the cross-device data transfer based on the request-responding mode according to an embodiment of the present disclosure. The cross-device data transfer system may at least include the cross-device data transfer network unit 130 and the WebSocket server 140. Additionally, from a broader perspective, the cross-device data transfer system may further cover the functional module integrated in the target application 112 for implementing processing associated with the embodiments of the present disclosure, and the device client 122.

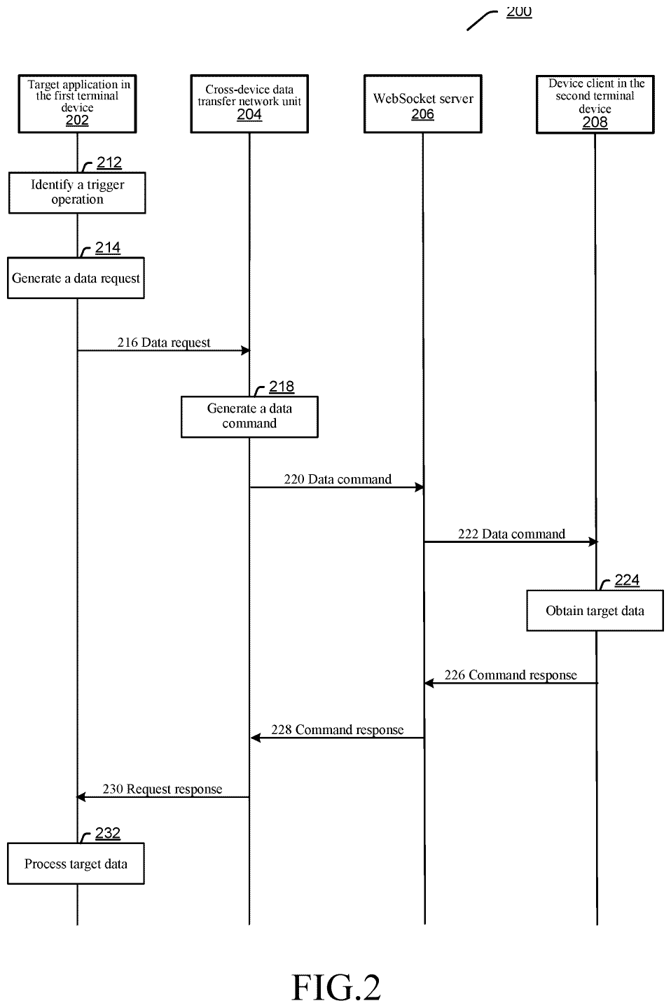

Furthermore, it should be understood that all elements in the architecture 100A and architecture 100B are exemplary and that embodiments of the present disclosure are not limited to any details of the elements shown in FIG. 1A and FIG. 1B, but may over more or fewer elements or details. FIG. 2 illustrates an exemplary process 200 of cross-device data transfer according to an embodiment. The process 200 may be performed to implement a cross-device data transfer mechanism based on a request-responding mode according to an embodiment of the present disclosure. The process 200 includes various exemplary processing performed at a target application 202 in a first terminal device, a cross-device data transfer network unit 204, a WebSocket server 206, and a device client 208 in a second terminal device.

At 212, the target application 202 may identify a trigger operation occurring in a user interface of the target application 202. The user may want to process, in the target application 202, the target data in the second terminal device, e.g., perform various operations such as presenting, editing, inserting, sending, sharing, etc., on the target data, then the user may perform the trigger operation in the user interface of the target application 202, so as to indicate to obtain the target data in the second terminal device.

In different application scenarios, there may be different types of trigger operations and different types of target data.

In an implementation, the trigger operation may include designation of the second terminal device, e.g., selecting operation for the second terminal device. For example, the user may click on visual elements such as options and buttons in the user interface to select the second terminal device. In this case, the target data may include metadata associated with the resources under the predetermined resource directory in the second terminal device, so that the user may know which resources are included in the predetermined resource directory and related information of these resources through viewing the metadata. Herein, the metadata of a resource may include various descriptive information related to the resource, e.g., metadata of a file resource may include the name or identification (ID), size, creation time, modification time, thumbnail, etc., of the file; metadata of a message resource may include ID, sender, receiver, date and time, read status, etc., of the message; and contact information resource may include name or ID, phone number, email address, etc., of the contact. As an example, assuming that an option box associated with “insert a picture” has been presented in the user interface of the target application, and the option box includes at least an option button for selecting the second terminal device as the source of the picture, then a trigger operation performed by the user, such as clicking the option button, may indicate to obtain metadata of multiple photo files and video files included in the “camera” file directory in the second terminal device. In this example, the camera file directory in the second terminal device is the predetermined resource directory associated with the trigger operation performed in the “insert picture” option box in the target application. It should be understood that the embodiments of the present disclosure are not limited to any specific mapping relationship between the trigger operation for designating the second terminal device and the predetermined resource directory, e.g., the predetermined resource directory associated with the trigger operation for designating the second terminal device performed in the “attach a file” option box in the target application may be a root directory in the second terminal device, etc.

In an implementation, the trigger operation may include designation of a resource directory in the second terminal device, e.g., selecting operation for specific resource directory in the second terminal device. For example, assuming that multiple resource directories in the second terminal device have been presented in the user interface of the target application, then the user may click on a specific resource directory of the multiple resource directories to select the specific resource directory. In this case, the target data may include metadata associated with the resources under the designated resource directory in the second terminal device, so that the user may know which resources are included in the designated resource directory and related information of these resources through viewing the metadata. As an example, assuming that the root directory in the second terminal device has been presented in the user interface of the target application, and the root directory includes a plurality of file directories as resource directories, then a trigger operation performed by the user, such as clicking on a certain file directory of the plurality of file directories, may indicate to obtain metadata of files included in the designated file directory in the second terminal device.

In an implementation, the trigger operation may include designation of a resource in the second terminal device, e.g., selecting operation for a specific resource in the second terminal device. For example, assuming that the metadata associated with a plurality of resources in the second terminal device has been presented in the user interface of the target application, then the user may click on a visual element associated with the metadata of a specific resource of the plurality of resources to select the specific resource. In this case, the target data may include the designated resource in the second terminal device, so that the designated resource may be transferred to the target application for processing, e.g., presented in the user interface of the target application. As an example, assuming that the metadata of a plurality of photo files and video files included in the “camera” file directory in the second terminal device has been presented in the user interface of the target application, then a trigger operation performed by the user, such as clicking a visual element associated with the metadata of a photo file of the plurality of photo files and video files, may indicate to obtain the designated photo file in the second terminal device.

In an implementation, the trigger operation may include designation of a part of a resource in the second terminal device, e.g., selecting operation for a specific part of a specific resource in the second terminal device. For example, assuming that the metadata associated with a plurality of resources in the second terminal device has been presented in the user interface of the target application, then the user may first click on a visual element associated with the metadata of a specific resource of the plurality of resources to select the specific resource, and further set or input information for designating the specific part of the specific resource. In this case, the target data may include the designated part of the designated resource in the second terminal device, so that the designated part of the designated resource may be transferred to the target application for processing. Herein, a designated part of a resource may refer to a designated segment in the entire resource, e.g., a video segment within a designated time interval in a video file, a page in a designated page number range in a document file, etc. As an example, assuming that the metadata of a plurality of photo files and video files included in the “camera” file directory in the second terminal device has been presented in the user interface of the target application, then a first operation performed by the user, such as clicking on a visual element associated with the metadata of a video file of the plurality of photo files and video files, may select the designated video file in the second terminal device, and a second operation performed by the user, such as setting the time interval from the 2nd second to the 10th second, may further indicate to obtain the designated video segment in the designated video file located within the time interval. The first operation and the second operation may be considered together as a trigger operation for designating a designated video segment of the designated video file in the second terminal device.

It should be understood that the embodiments of the present disclosure are not limited to the exemplary trigger operations and target data described above, but may cover any other types of trigger operations and target data.

At 214, the target application 202 may generate a data request in response to the identified trigger operation. The data request may at least include a resource describing statement corresponding to the target data indicated by the trigger operation. According to an embodiment of the present disclosure, a set of resource describing statements may be predefined, and each resource describing statement may be used to describe a path for obtaining of corresponding target data. In an implementation, the resource describing statement may be defined with a API. Taking the resource describing statement being defined with a REST API as an example, a set of REST APIs may be predefined, and each REST API may describe the path for obtaining of the corresponding target data. In an implementation, the resource describing statement may be defined with an API and a corresponding parameter, and the parameter may be an additional description of the API. Taking the target data being a designated part of a designated resource as an example, the API may be used to describe the path for obtaining of the designated resource, and the corresponding parameter may be used to describe the designated part, e.g., time interval, page number range, etc. It should be understood that the embodiments of the present disclosure are neither limited to any specific format of the resource describing statement, nor limited to employing the API and possible corresponding parameters to define the resource describing statement, nor limited to any specific format of the API. Additionally, it should be understood that, in addition to the resource describing statement, the data request may also include any other possible information, e.g. address, URL path, header information, etc., of the network unit or server receiving the data request.

At 216, data request transport from the target application 202 to the cross-device data transfer network unit 204 may be performed. For example, the target application 202 may send a data request to the cross-device data transfer network unit 204, and accordingly, the cross-device data transfer network unit 204 may receive the data request from the target application 202. In an implementation, a http connection may be established between the target application 202 and the cross-device data transfer network unit 204 for data request transport.

At 218, the cross-device data transfer network unit 204 may generate a data command based on the resource describing statement in the data request. The data command may indicate to obtain the target data in the second terminal device. The data command employs a format that the device client 208 in the second terminal device may understand or parse, so that the device client 208 may know what target data needs to be obtained for responding based on the data command. In an implementation, if the device client 208 has the ability to directly understand or parse the resource describing statement, the cross-device data transfer network unit 204 may directly use the resource describing statement as the data command at 218, and such a data command may include, e.g., the path for obtaining of the target data, etc. In an implementation, if the device client 208 does not have the ability to understand or parse the resource describing statement, the cross-device data transfer network unit 204 may convert the resource describing statement into the data command at 218 according to the terminal data protocol, and such a data command may include, e.g., command name, folder name, resource name or ID, etc. The terminal data protocol is predefined for the device client 208 in the second terminal device, which enables the device client 208 to understand or parse the data command. Embodiments of the present disclosure are not limited to any particular generation approach of the data command, nor to any particular details of the terminal data protocol described above.

After generating the data command, the cross-device data transfer network unit 204 may then send the data command to the device client 208. Preferably, the cross-device data transfer network unit 204 may send the data command to the device client 208 through the WebSocket connection established by using the WebSocket server 206. For example, at 220, the cross-device data transfer network unit 204 may send the data command to the WebSocket server 206, and accordingly, the WebSocket server 206 may receive the data command from the cross-device data transfer network unit 204. A WebSocket connection may be established between the cross-device data transfer network unit 204 and the WebSocket server 206 for data command transport. At 222, the WebSocket server 206 may send the data command to the device client 208, and accordingly, the device client 208 may receive the data command from the cross-device data transfer network unit 204 through the WebSocket connection established by using the WebSocket server 206. A WebSocket connection may be established between the WebSocket server 206 and the device client 208 for data command transport. It should be understood that the embodiments of the present disclosure are not limited to any specific implementation with which the WebSocket server 206 receives the data command from the cross-device data transfer network unit 204 and sends the data command to the device client 208.

At 224, the device client 208 may obtain the target data based on the data command. For example, the device client 208 may parse the data command directly or according to the terminal data protocol, and accordingly, obtain the requested target data from the second terminal device. Different types of target data may cause the device client 208 to perform different target data obtaining operations at 224. For example, in the case where the target data is metadata of resources under the predetermined resource directory or the designated resource directory in the second terminal device, the device client 208 may obtain the metadata contained in the source files of these resources from the storage unit of the second terminal device based on the data command. For example, in the case where the target data is the designated resource in the second terminal device, the device client 208 may obtain the source file of the designated resource from the storage unit of the second terminal device based on the data command. For example, in the case where the target data is the designated part of the designated resource in the second terminal device, the device client 208 may extract the designated resource from the storage unit of the second terminal device based on the data command, and then extract the designated part from the designated resource based on the data command.

After obtaining the target data, the device client 208 may further send a command response to the cross-device data transfer network unit 204. The command response includes at least the obtained target data. The command response may be generated according to the terminal data protocol, so that the cross-device data transfer network unit 204 may extract the target data from the command response according to the terminal data protocol. Preferably, the device client 208 may send the command response to the cross-device data transfer network unit 204 through the WebSocket connection established by using the WebSocket server 206. For example, at 226, the device client 208 may send the command response to the WebSocket server 206, and accordingly, the WebSocket server 206 may receive the command response from the device client 208. A WebSocket connection may be established between the device client 208 and the WebSocket server 206 for command response transport. At 228, the WebSocket server 206 may send the command response to the cross-device data transfer network unit 204, and accordingly, the cross-device data transfer network unit 204 may receive the data command from the device client 208 through the WebSocket connection established by using the WebSocket server 206. A WebSocket connection may be established between the WebSocket server 206 and the cross-device data transfer network unit 204 for command response transport. It should be understood that the embodiments of the present disclosure are not limited to any particular implementation with which the WebSocket server 206 receives the command response from the device client 208 and sends the command response to the cross-device data transfer network unit 204.

After receiving the command response, the cross-device data transfer network unit 204 may generate, based on the command response, a request response as a response to the data request. For example, the cross-device data transfer network unit 204 may extract the target data from the command response and include the extracted target data into the request response.

At 230, a request response transport from the cross-device data transfer network unit 204 to the target application 202 may be performed. For example, the cross-device data transfer network unit 204 may send the request response to the target application 202, and accordingly, the target application 202 may receive the request response from the cross-device data transfer network unit 204. In an implementation, a http connection may be established between the target application 202 and the cross-device data transfer network unit 204 for request response transport.

At 232, the target application 202 may process the target data contained in the received request response. The target data may be processed in various ways, e.g., the target data is presented, shared, sent, edited, etc. Embodiments of the present disclosure are not limited to any particular processing performed by the target application 202 on the target data.

It should be understood that all the steps and operations in the process 200 are exemplary, and embodiments of the present disclosure will cover any modification to the process 200. For example, embodiments of the present disclosure are not limited to employing the WebSocket server 206 to transmit the data command and the command response, but may cover any other approach for sending the data command from the cross-device data transfer network unit 204 to the device client 208 and any other approach for sending the command response from the device client 208 to the cross-device data transfer network unit 204.

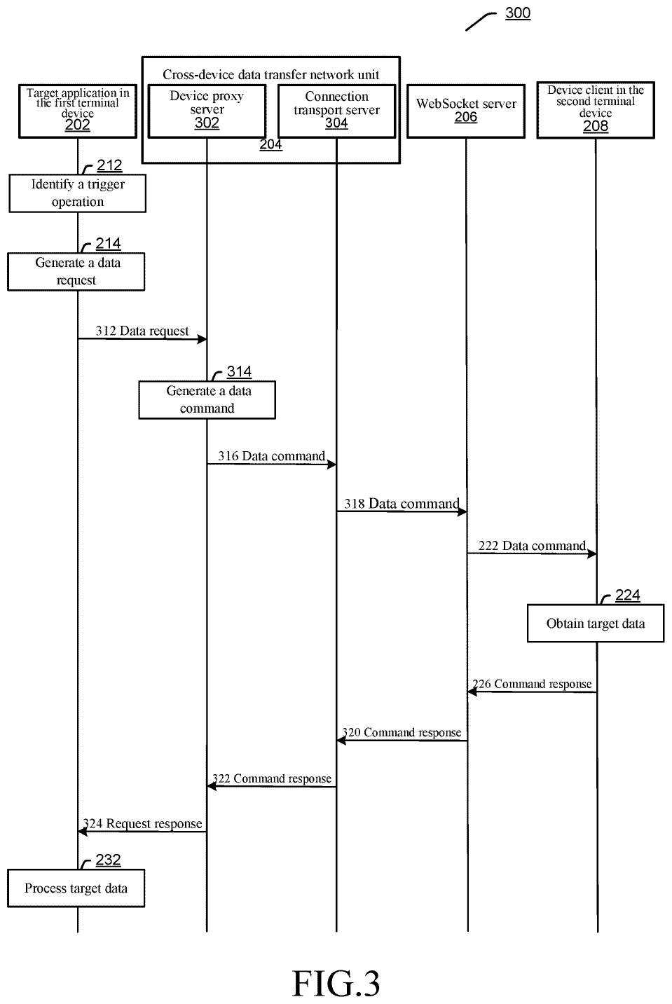

FIG. 3 illustrates an exemplary process 300 of cross-device data transfer according to an embodiment. The process 300 in FIG. 3 is a further implementation of the process 200 in FIG. 2, and the same reference numerals in FIG. 2 and FIG. 3 may indicate the same steps, operations, execution subjects, etc. FIG. 3 shows a situation where the cross-device data transfer network unit 204 includes a device proxy server 302 and a connection transport server 304, and the process 300 includes steps and operations involving the device proxy server 302 and the connection transport server 304. For the sake of brevity, the following discussion will not repeatedly describe the same steps and operations involved in process 300 and process 200.

At 312, a data request transport from the target application 202 to the device proxy server 302 may be performed. For example, the target application 202 may send a data request to the device proxy server 302, and accordingly, the device proxy server 302 may receive the data request from the target application 202. In an implementation, a http connection may be established between the target application 202 and the device proxy server 302 for data request transport.

At 314, the device proxy server 302 may generate a data command based on the resource describing statement in the data request. The data command generation operation at 314 is similar to the data command generation operation at 218 in FIG. 2.

At 316, a data command transport from the device proxy server 302 to the connection transport server 304 may be performed. For example, the device proxy server 302 may send a data command to the connection transport server 304, and accordingly, the connection transport server 304 may receive the data command from the device proxy server 302. In an implementation, a http connection may be established between the device proxy server 302 and the connection transport server 304 for data command transport.

After receiving the data command, the connection transport server 304 may then send the data command to the device client 208. Preferably, the connection transport server 304 may send the data command to the device client 208 through the WebSocket connection established by using the WebSocket server 206. For example, at 318, the connection transport server 304 may send the data command to the WebSocket server 206, and accordingly, the WebSocket server 206 may receive the data command from the connection transport server 304. A WebSocket connection may be established between the connection transport server 304 and the WebSocket server 206 for data command transport.

After receiving the command response from the device client 208, the WebSocket server 206 may send the command response to the connection transport server 304 at 320, and accordingly, the connection transport server 304 may receive the data command from the device client 208 through the WebSocket connection established by using the WebSocket server 206. A WebSocket connection may be established between the WebSocket server 206 and the connection transport server 304 for command response transport.

At 322, a command response transport from the connection transport server 304 to the device proxy server 302 may be performed. For example, the connection transport server 304 may send the command response to the device proxy server 302, and accordingly, the device proxy server 302 may receive the command response from the connection transport server 304. In an implementation, a http connection may be established between the connection transport server 304 and the device proxy server 302 for command response transport.

After receiving the command response, the device proxy server 302 may generate, based on the command response, a request response as a response to the data request. The request response may include at least the target data extracted from the command response.

At 324, a request response transport from the device proxy server 302 to the target application 202 may be performed. For example, the device proxy server 302 may send the request response to the target application 202, and accordingly, the target application 202 may receive the request response from the device proxy server 302. In an implementation, a http connection may be established between the target application 202 and the device proxy server 302 for request response transport.

According to an embodiment of the present disclosure, the resource describing statement may be defined with API. Preferably, the resource describing statement may be defined with REST API. An exemplary API format may be/devices/{device-ID}/resources/{resource-ID}, where “devices” represents a “device” field, and “device-ID” represents ID of the second terminal device, “resources” represents a “resource” field, and “resource-ID” represents ID of the resource. For different types of resources, the format of the API described above may be transformed accordingly. For example, in the case where the resource is a file, the format of the API may be transformed into/devices/{device-ID}/files/{file-ID}, where “files” represents a “file” field, and “file-ID” represents ID of the file. For example, in the case where the resource is a message, the format of the API may be transformed into/devices/{device-ID}/messages/{message-ID}, where “messages” represents a “message” field, and “message-ID” represents ID of the message. For example, in the case where the resource is contact information, the format of the API may be transformed into/devices/{device-ID}/contacts/{contact-ID}, where “contacts” represents a “contact” field, and “contact-ID” indicates ID of the contact. It should be understood that the various formats of the API and the fields therein described above are exemplary, and embodiments of the present disclosure are not limited to these examples, but will cover any other API format and more or less other fields. Additionally, in some cases, the resource describing statement may be further defined with a parameter corresponding to the API. A parameter of API is an additional description of the API. For example, the parameter {“selectFrom”:, “selectTo”:} may define a time interval, a page number range, etc., where “selectFrom” represents the selected start position, and “selectTo” represents the selected end position. Depending on specific applications, embodiments of the present disclosure will also cover more other types of API parameters.

According to an embodiment of the present disclosure, in the case of the resource describing statement is converted into the data command according to the terminal data protocol, a specific statement describing format may be defined for the data command. One data command statement may be formed by a plurality of fields, and these fields may take the form of e.g., key-value. Exemplary fields may include a “commandName” field representing a command name, a “folderName” field representing a folder name, a “resourceID” field representing a resource ID, a “resourceName” field representing a resource name, a “selectFrom” field representing a selected start position, a “selectTo” field representing an end position, etc. The fields in the resource describing statement and the fields in the data command may have a predetermined mapping relationship, so that the data command may fully reflect the information in the resource describing statement. It should be understood that the statement describing formats of the data command and the fields therein described above are exemplary, and embodiments of the present disclosure are not limited to these examples, but will cover any other data command statement describing format and more or less other fields.

According to an embodiment of the present disclosure, a specific statement describing format may be defined for metadata of a resource, which may also be referred to as, e.g., a resource model, etc. A metadata describing statement may be formed by a plurality of fields, and these fields may take the form of e.g., key-value. The fields in the metadata describing statement are used to represent various information in the metadata, and for different types of resources, the field types in the metadata describing statement may be different. For example, in the case where the resource is a file, the format of the metadata describing statement may be {“file-ID”:, “name”:, “type”:, “lastModifiedDateTime”:, . . . }, where “file-ID” represents the ID of the file, “name” represents the name of the file, “type” represents the type of the file, and “lastModifiedDateTime” represents the date and time when the last modification was made. For example, in the case where the resource is a message, the format of the metadata describing statement may be {“message-ID”:, “content”:, “receiver”:, “sender”:, “dateTime”:, “isRead”, . . . }, where “message-ID” represents the ID of the message, “content” represents the content of the message, “receiver” represents the receiver of the message, “sender” represents the sender of the message, and “dateTime” represents the date and time when the message was sent, and “isRead” represents whether the message has been read. For example, in the case where the resource is contact information, the format of the metadata describing statement may be {“contact-ID”:, “name”:, “phoneNumber”:, “dateTime”:, . . . }, where “contact-ID” represents the ID of the contact, “name” represents the name of the contact, “phoneNumber” represents the phone number of the contact, and “dateTime” represents the date and time when the contact information was created. It should be understood that the various formats of the metadata describing statement and the fields therein described above are exemplary, and embodiments of the present disclosure are not limited to these examples, but will cover any other metadata describing statement format and more or less other fields.

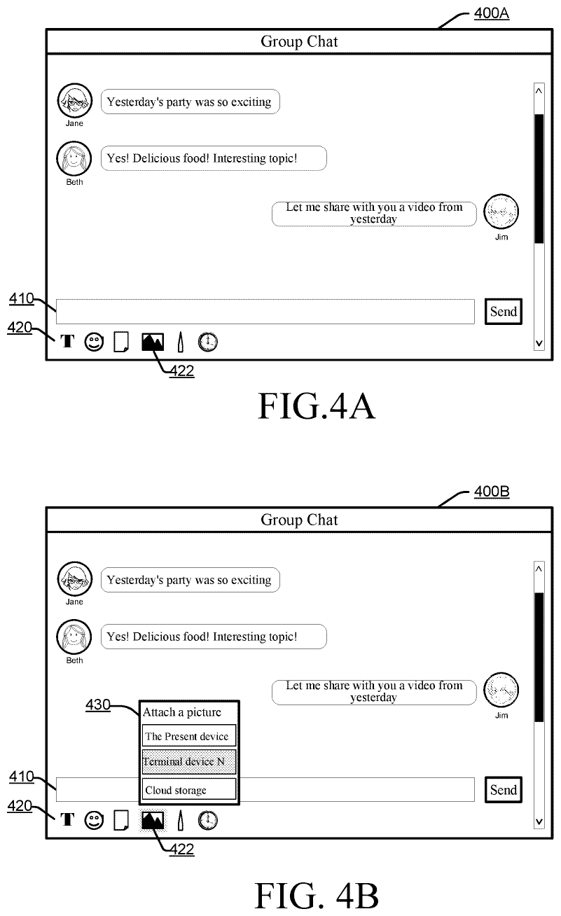

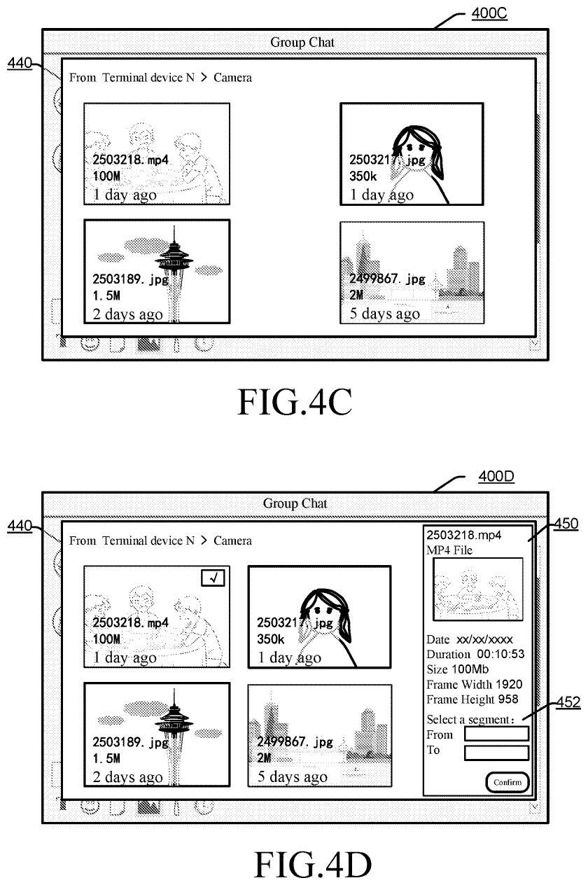

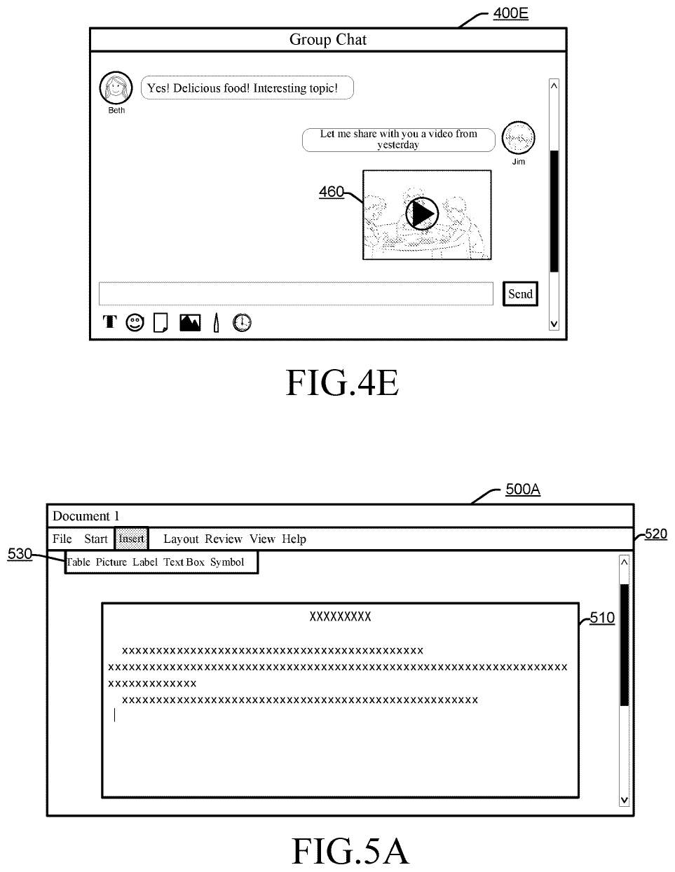

FIG. 4A, FIG. 4B, FIG. 4C, FIG. 4D and FIG. 4E illustrate an exemplary application scenario according to an embodiment. In this application scenario, the first terminal device is a desktop computer, the second terminal device is a terminal device N e.g., a smart phone, and the target application is a social media application running on the desktop computer. FIG. 4A, FIG. 4B,

FIG. 4C, FIG. 4D and FIG. 4E illustrate the group chat user interface of the social media application. Assume that user Jim is the owner of the desktop computer and the terminal device N, and he wants to share video resources stored in the terminal device N with other chatting users, e.g., Jane, Beth, etc., in the group chat user interface.

In FIG. 4A, the user interface of the social media application has a visual display 400A that includes at least, e.g., an input box 410, an icon bar 420, etc. The icon bar 420 includes a plurality of icons that may be selected, each icon corresponding to a different type of input information. For example, the icon bar 420 includes at least an icon 422 for attaching a picture.

Assuming that user Jim clicks on the icon 422 in the visual display 400A, the user interface of the social media application is updated as visual display 400B in FIG. 4B. As shown in FIG. 4B, an option box 430 associated with the icon 422 is presented. The option box 430 includes, e.g., an option button for selecting the present device (i.e., the desktop computer) as the picture source, an option button for selecting the terminal device N as the picture source, an option button for selecting cloud storage as the picture source, etc.

Assuming that the user Jim clicks on the option button for selecting the terminal device N as the picture source in the option box 430 in the visual display 400B, the social media application may identify the click operation as a trigger operation, and the trigger operation is the designation of the terminal device N. The trigger operation may indicate to obtain the target data in the terminal device N, e.g., metadata associated with photo and video resources under the predetermined resource directory “camera” in the terminal device N. The social media application may generate a data request in response to the trigger operation, and the data request includes a resource describing statement corresponding to the target data. Taking the resource describing statement being defined with API as an example, the format of the API corresponding to the target data may be, e.g.,/devices/{device-ID}/files/camera, where “device-ID” is the ID of the terminal device N, and “camera” represents the “camera” directory. Taking the cross-device data transfer network unit including a device proxy server and a connection transport server as an example, the social media application may further send the data request to the device proxy server.

The device proxy server may convert the API in the data request to a data command. The data command may be, e.g., {“commandName”: “GetMediaList”, “folderName”: “camera”}, where “GetMediaList” is the value of “commandName” which represents “get the media list”, and “camera” is the value of “folderName”, which represents the “camera” folder. The data command is finally sent to the device client in the terminal device N through the connection transport server and the WebSocket server.

The device client in the terminal device N obtains the target data, e.g., metadata associated with photo and video resources under the “camera” directory in the terminal device N, based on the data command. The device client incorporates the target data into the command response. The command response is finally sent to the device proxy server through the WebSocket server and the connection transport server.

The device proxy server extracts the target data in the command response and incorporates the target data into the request response. The device proxy server sends the request response to the social media application.

The social media application extracts the target data in the request response and presents the target data in the user interface. For example, the user interface of the social media application is updated as visual display 400C in FIG. 4C. The object data is presented in the box 440 in the visual display 400C, e.g., metadata associated with photo and video resources under the “camera” directory in the terminal device N. Assuming that the “camera” directory in the terminal device N includes a video named “2503218”, a photo named “2503217”, a photo named “2503189”, a photo named “2499867”, etc., metadata for these videos and photos is shown in the box 440, e.g., thumbnail, name, type, size, shooting time, etc.

Assuming that user Jim clicks on the thumbnail of the video named “2503218” in the visual display 400C to indicate that user Jim wants to select this video, the user interface of the social media application is updated as visual display 400D in FIG. 4D. The box 450 in the visual display 400D includes information associated with the video and a region 452 for selecting or setting a segment of the video. Assuming that user Jim does not want to share the entire video, but just wants to share a segment of the video, then user Jim may set the time interval of the segment to be shared in the region 452, e.g., enter “00:00:00” in the input box after “From” as the start time point of the segment, and enter “00:10:00” in the input box after “To” as the end time point of the segment. Accordingly, the segment is set to be within the time interval from the 0th second to the 10th second of the video. User Jim may then confirm his settings with the “Confirm” button in the region 452. The social media application may at least identify the operation of clicking on the thumbnail of the video in the visual display 400C and the operation of setting the time interval of the segment in the visual display 400D together as the trigger operation, and the trigger operation is designation of a part of a resource in the terminal device N. The trigger operation may indicate to obtain the target data in the terminal device N, e.g., the segment of the video. The social media application may generate a data request in response to the trigger operation, and the data request includes a resource describing statement corresponding to the target data. Taking the resource describing statement being defined with API as an example, the format of the API corresponding to the target data may be, e.g.,/devices/{device-ID}/files/{file-ID}/download, where “file-ID” is the ID of the video “2503218”, and “download” represents a “download” operation. Furthermore, since the segment of the video is designated, the parameter corresponding to the API described above may be, e.g., {“selectFrom”: “00:00:00”, “selectTo”: “00:10:00”}, where “00:00:00” is the value of “selectFrom”, which indicates that the start time point of the segment is the 0th second, and “00:10:00” is the value of “selectTo”, which indicates that the end time point of the segment is the 10th second. The social media application may further send the data request to the device proxy server.

The device proxy server may convert the API in the data request to a data command. The data command may, e.g., {“commandName”: “GetMediaFileData”, “file-ID”: “2503218”, “selectFrom”: “00:00:00”, “selectTo”: “00:10:00”}, where “GetMediaFileData” is the value of “commandName”, which means “get media file data”, and “2503218” is the value of “file-ID”, which corresponds to the ID of the video. The data command is finally sent to the device client in the terminal device N through the connection transport server and the WebSocket server.

The device client in the terminal device N obtains target data based on the data command. For example, the device client first loads the source file of the video named “2503218” from the storage unit of the terminal device N into the memory, and then processes the source file to cut a segment from the 0th second to the 10th second. The device client incorporates the target data into the command response. The command response is finally sent to the device proxy server through the WebSocket server and the connection transport server.

The device proxy server extracts the target data in the command response and incorporates the target data in the request response. The device proxy server sends the request response to the social media application.

The social media application extracts the target data in the request response and sends or shares the target data in the user interface. For example, the user interface of the social media application is updated as visual display 400E in FIG. 4E. It is shown in the visual display 400E that a designated segment 460 of video “2503218” has been shared with other users in the chat stream. It should be understood that all elements in FIG. 4A, FIG. 4B, FIG. 4C, FIG. 4D and FIG. 4E are exemplary, and all operations described above in connection with FIG. 4A, FIG. 4B, FIG. 4C, FIG. 4D and FIG. 4E are also exemplary.

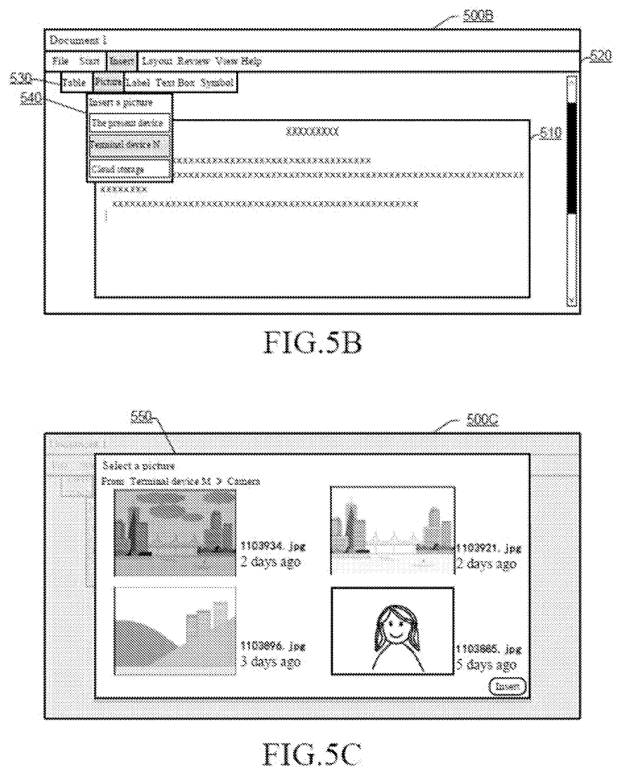

FIG. 5A, FIG. 5B, FIG. 5C and FIG. 5D illustrate an exemplary application scenario according to an embodiment. In this application scenario, the first terminal device is a desktop computer, the second terminal device is a terminal device M e.g., a smart phone, and the target application is a file editor running on the desktop computer. FIG. 5A, FIG. 5B, FIG. 5C and FIG. 5D illustrate the user interface of the file editor. Assume that a user wants to insert a picture resource stored in the terminal device M into the document being edited in the file editor.

In FIG. 5A, the user interface of the file editor has a visual display 500A that includes at least, e.g., a document region 510, a toolbar 520, etc. The toolbar 520 includes a plurality of function buttons that may be selected. For example, the toolbar 520 includes at least an “Insert” button for inserting content into a document. Assuming that the user has clicked on the “Insert” button, a drop-down box 530 associated with the insert function is presented. The drop-down box 530 includes at least a “Picture” button for inserting a picture.

Assuming that the user clicks on the “Picture” button in the visual display 500A, the user interface of the file editor is updated as visual display 500B in FIG. 5B. As shown in FIG. 5B, an option box 540 associated with the “Picture” button is presented. The option box 540 includes, e.g., an option button for selecting the present device (i.e., the desktop computer) as the picture source, an option button for selecting the terminal device M as the picture source, an option button for selecting cloud storage as the picture source, etc.

Assuming that the user clicks on the option button for selecting the terminal device M as the picture source in the option box 540 in the visual display 500B, the file editor may identify the click operation as a trigger operation, and the trigger operation is the designation of the terminal device M. The trigger operation may indicate to obtain the target data in the terminal device M, e.g., metadata associated with photo and video resources under the predetermined resource directory “camera” in the terminal device M. The file editor may generate a data request in response to the trigger operation, and the data request includes a resource describing statement corresponding to the target data. Taking the cross-device data transfer network unit including a device proxy server and a connection transport server as an example, the file editor may further send the data request to the device proxy server.

The device proxy server may convert the API in the data request to a data command. The data command is finally sent to the device client in the terminal device M through the connection transport server and the WebSocket server.

The device client in the terminal device M obtains the target data, e.g., metadata associated with photo and video resources under the “camera” directory in the terminal device M, based on the data command. The device client incorporates the target data into the command response. The command response is finally sent to the device proxy server through the WebSocket server and the connection transport server.

The device proxy server extracts the target data in the command response and incorporates the target data into the request response. The device proxy server sends the request response to the file editor.

The file editor extracts the target data in the request response and presents the target data in the user interface. For example, the user interface of the file editor is updated as visual display 500C in FIG. 5C. The object data is presented in the box 550 in the visual display 500C, e.g., metadata associated with photo and video resources under the “camera” directory in the terminal device M. Assuming that the user clicks on the thumbnail of the photo named “1103921” in the visual display 500C to indicate that the user wants to select the photo, the file editor may identify the click operation as the trigger operation, and the trigger operation is the designation of the resources in the terminal device M. The trigger operation may indicate to obtain the target data in the terminal device M, e.g., the photo “1103921”. The file editor may generate the data request in response to the trigger operation, and the data request includes a resource describing statement corresponding to the target data. The file editor may further send the data request to the device proxy server. The device proxy server may convert the API in the data request to a data command. The data command is finally sent to the device client in the terminal device M through the connection transport server and the WebSocket server.

The device client in the terminal device M obtains the target data based on the data command. For example, the device client extracts the source file of the photo “1103921” from the storage unit of the terminal device M. The device client incorporates the target data into the command response. The command response is finally sent to the device proxy server through the WebSocket server and the connection transport server.

The device proxy server extracts the target data in the command response and incorporates the target data in the request response. The device proxy server sends the request response to the file editor.

The file editor extracts the target data in the request response, and inserts the target data into the document being edited. For example, the user interface of the file editor is updated as visual display 500D in FIG. 5D. In the visual display 500D, it is shown that the photo “1103921” has been inserted into the document region 510 as picture 560.

It should be understood that all elements in FIG. 5A, FIG. 5B, FIG. 5C and FIG. 5D are exemplary, and all operations described above in connection with FIG. 5A, FIG. 5B, FIG. 5C and FIG. 5D are also exemplary.

Additionally, it should be understood that embodiments of the present disclosure are not limited to the application scenarios in FIG. 4A, FIG. 4B, FIG. 4C, FIG. 4D and FIG. 4E and the application scenarios in FIG. 5A, FIG. 5B, FIG. 5C and FIG. 5D, but may have more other application scenarios. Embodiments of the present disclosure may enable any target application in the first terminal device to obtain various types of target data from the second terminal device for processing. For example, in the case where the target application in the first terminal device is a file browser, embodiments of the present disclosure may enable the user to view, in the file browser, files stored in the second terminal device, and accordingly, the second terminal device may be regarded as an extension of the first terminal device. For example, in the case where the target application in the first terminal device is an online meeting application, embodiments of the present disclosure may enable the user to obtain and share, in the online meeting application, resources stored in the second terminal device. For example, in the case where the target application in the first terminal device is an email application, embodiments of the present disclosure may enable the user to obtain and use, in the email application, various resources stored in the second terminal device, e.g., to insert a file stored in the second terminal device into the e-mail, to obtain the contact information in the second terminal device and initiate an e-mail for a specific contact, etc. Embodiments of the present disclosure are in no way limited by the exemplary application scenarios described above.

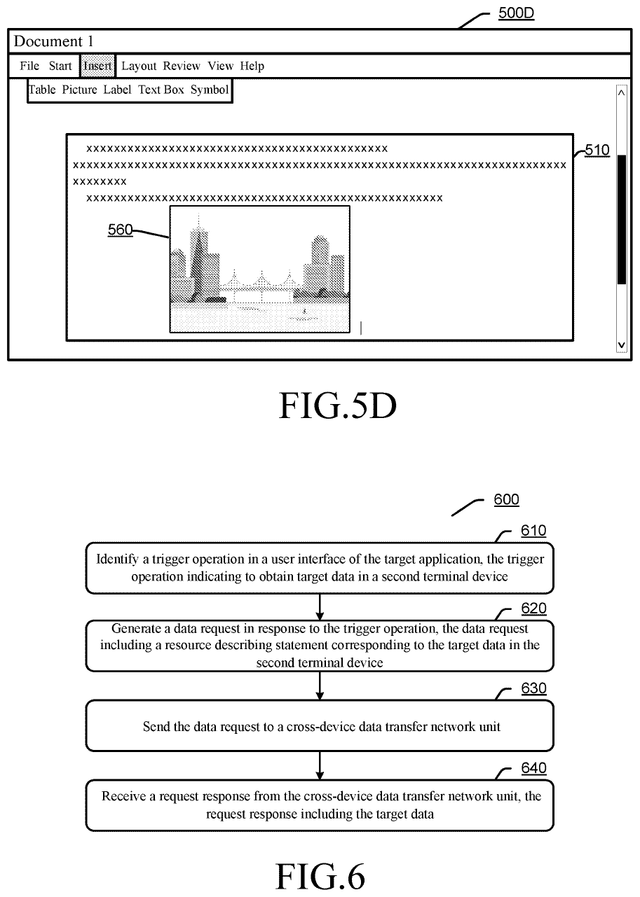

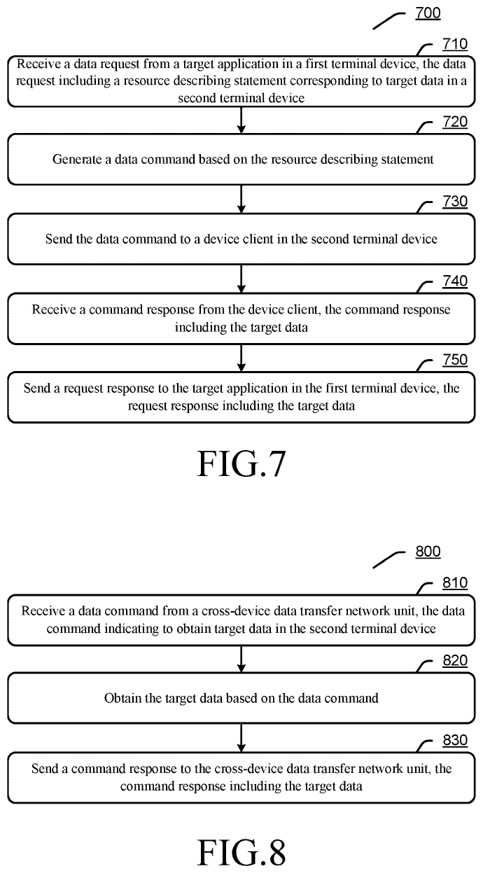

FIG. 6 illustrates a flowchart of an exemplary method 600 for cross-device data transfer according to an embodiment. The method 600 may be implemented by a target application in a first terminal device.

At 610, a trigger operation may be identified in a user interface of the target application, the trigger operation indicating to obtain target data in a second terminal device.

At 620, a data request may be generated in response to the trigger operation, the data request including a resource describing statement corresponding to the target data in the second terminal device.

At 630, the data request may be sent to a cross-device data transfer network unit.

At 640, a request response may be received from the cross-device data transfer network unit, the request response including the target data.

In an implementation, the trigger operation may include at least one of: designation of the second terminal device; designation of a resource directory in the second terminal device; designation of a resource in the second terminal device; and designation of a part of a resource in the second terminal device. The target data may include at least one of: metadata associated with resources in a predetermined resource directory in the second terminal device; metadata associated with resources in a designated resource directory in the second terminal device; a designated resource in the second terminal device; and a designated part of a designated resource in the second terminal device.

In an implementation, the sending the data request may include: sending the data request to the cross-device data transfer network unit through a http connection. The receiving a request response may include: receiving the request response from the cross-device data transfer network unit through a http connection.

In an implementation, the resource describing statement may be defined at least with an API corresponding to the trigger operation.

It should be understood that the method 600 may further include any steps/operations for cross-device data transfer implemented by a target application in a first terminal device according to an embodiment of the present disclosure described above.

FIG. 7 illustrates a flowchart of an exemplary method 700 for cross-device data transfer according to an embodiment. The method 700 may be implemented by a cross-device data transfer network unit.

At 710, a data request may be received from a target application in a first terminal device, the data request including a resource describing statement corresponding to target data in a second terminal device.

At 720, a data command may be generated based on the resource describing statement.

At 730, the data command may be sent to a device client in the second terminal device.

At 740, a command response from the device client may be received, the command response including the target data.

At 750, a request response may be sent to the target application in the first terminal device, the request response including the target data.

In an implementation, the generating a data command may include: converting the resource describing statement into the data command according to a terminal data protocol; or taking the resource describing statement as the data command.

In an implementation, the receiving a data request may include: receiving the data request from the target application in the first terminal device through a http connection. The sending a request response may include: sending the request response to the target application in the first terminal device through a http connection.

In an implementation, the sending the data command may include: sending the data command to the device client in the second terminal device through a WebSocket connection established by using a WebSocket server. The receiving a command response from the device client may include: receiving the command response from the device client through a WebSocket connection established by using the WebSocket server.

In an implementation, the resource describing statement may be defined with an API, or defined with an API and a corresponding parameter. The API may be a REST API.

It should be understood that the method 700 may further include any steps/operations for cross-device data transfer implemented by a cross-device data transfer network unit according to an embodiment of the present disclosure described above.

FIG. 8 illustrates a flowchart of an exemplary method 800 for cross-device data transfer according to an embodiment. The method 800 may be implemented by a device client in a second terminal device.

At 810, a data command from a cross-device data transfer network unit may be received, the data command indicating to obtain target data in the second terminal device.

At 820, the target data may be obtained based on the data command.

At 830, a command response may be sent to the cross-device data transfer network unit, the command response including the target data.

In an implementation, the target data may be a designated part of a designated resource in the second terminal device. The obtaining the target data may include: extracting the designated resource from a storage unit in the second terminal device based on the data command; and extracting the designated part from the designated resource based on the data command. In an implementation, the receiving a data command from a cross-device data transfer network unit includes: receiving the data command from the cross-device data transfer network unit through a WebSocket connection established by using a WebSocket server. The sending a command response to the cross-device data transfer network unit may include: sending the command response to the cross-device data transfer network unit through a WebSocket connection established by using the WebSocket server.

It should be understood that the method 800 may further include any steps/operations for cross-device data transfer implemented by a device client in a second terminal device according to an embodiment of the present disclosure described above.

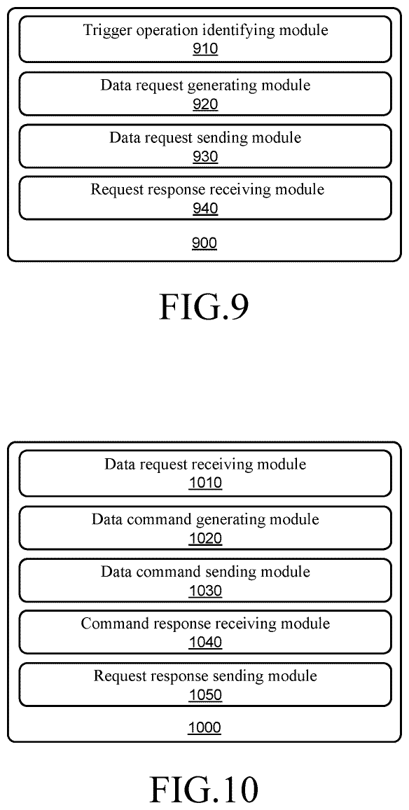

FIG. 9 illustrates an exemplary apparatus 900 for cross-device data transfer according to an embodiment. The apparatus 900 may be implemented in a target application in the first terminal device. The apparatus 900 may include: a trigger operation identifying module 910, for identifying a trigger operation in a user interface of the target application, the trigger operation indicating to obtain target data in a second terminal device; a data request generating module 920, for generating a data request in response to the trigger operation, the data request including a resource describing statement corresponding to the target data in the second terminal device; a data request sending module 930, for sending the data request to a cross-device data transfer network unit; and a request response receiving module 940, for receiving a request response from the cross-device data transfer network unit, the request response including the target data. Additionally, the method 900 may further include any other module that is configured to perform any step/operation for cross-device data transfer implemented by the target application in the first terminal device according to an embodiment of the present disclosure described above.

FIG. 10 illustrates an exemplary apparatus 1000 for cross-device data transfer according to an embodiment. The apparatus 1000 may be implemented in a cross-device data transfer network unit. The apparatus 1000 may include: a data request receiving module 1010, for receiving a data request from a target application in a first terminal device, the data request including a resource describing statement corresponding to target data in a second terminal device; a data command generating module 1020 for generating a data command based on the resource describing statement; a data command sending module 1030, for sending the data command to a device client in the second terminal device; a command response receiving module 1040, for receiving a command response from the device client, the command response including the target data; and a request response sending module 1050, for sending a request response to the target application in the first terminal device, the request response including the target data. Additionally, the method 1000 may further include any other module that is configured to perform any step/operation for cross-device data transfer implemented by the cross-device data transfer network unit according to an embodiment of the present disclosure described above.

FIG. 11 illustrates an exemplary apparatus 1100 for cross-device data transfer according to an embodiment. The apparatus 1100 may be implemented in a device client in a second terminal device. The apparatus 1100 may include: a data command receiving module 1110, for receiving a data command from a cross-device data transfer network unit, the data command indicating to obtain target data in the second terminal device; a target data obtaining module 1120, for obtaining the target data based on the data command; and a command response sending module 1130, for sending a command response to the cross-device data transfer network unit, the command response including the target data. Additionally, the method 1100 may further include any other module that is configured to perform any step/operation for cross-device data transfer implemented by the device client in the second terminal device according to an embodiment of the present disclosure described above.

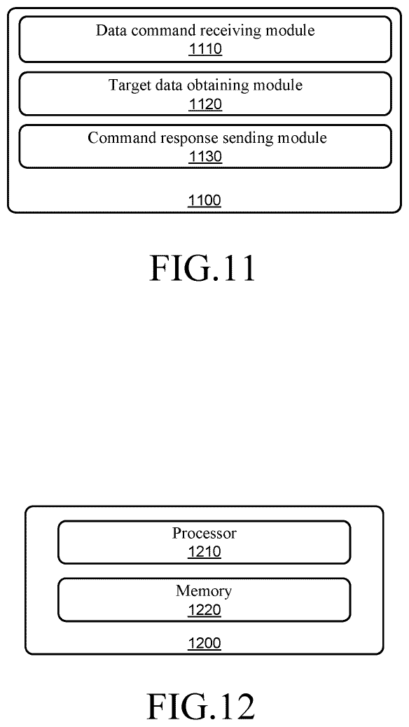

FIG. 12 illustrates an exemplary apparatus 1200 for cross-device data transfer according to an embodiment. The apparatus 1200 may include at least one processor 1210; and a memory 1220 storing computer-executable instructions. The computer-executable instructions, when executed, cause the at least one processor 1210 to perform any step/process of a method for cross-device data transfer according to embodiments of the disclosure as described above.

An embodiment of the present disclosure proposes a system for cross-device data transfer. The system may include a cross-device data transfer network unit and a WebSocket server. The cross-device data transfer network unit may include a device proxy server and a connection transport server. The device proxy server may be configured for: receiving a data request from a target application in a first terminal device, the data request including a resource describing statement corresponding to target data in a second terminal device; generating a data command based on the resource describing statement; sending the data command to the connection transport server; receiving a command response from the connection transport server, the command response including the target data; and sending a request response to the target application in the first terminal device, the request response including the target data. The connection transport server may be configured for: sending the data command received from the device proxy server to the WebSocket sever; and sending the command response received from the WebSocket server to the device proxy server. The WebSocket server may be configured for: sending the data command received from the connection transport server to a device client in the second terminal device; and sending the command response received from the device client to the connection transport server. In an implementation, the device proxy server may be configured for: communicating with the target application in the first terminal device through a http connection, and communicating with the connection transport server through a http connection.

In an implementation, the WebSocket server may be configured for: communicating with the connection transport server through a WebSocket connection, and communicating with the device client in the second terminal device through a WebSocket connection.

In an implementation, the device proxy server may be configured for: according to a terminal data protocol defined for the second terminal device, converting the resource describing statement into the data command, and extracting the target data from the command response.

In an implementation, the connection transport server may be configured for: according to a transport protocol defined for the second terminal device, performing transport layer processing to the data command and the command response.

In an implementation, the device proxy server and the connection transport server may be two separate network entities or locate in the same one network entity.

Additionally, the cross-device data transfer network unit, the WebSocket server, the device proxy server and the connection transport server may also be configured for performing any steps/operations for cross-device data transfer according to embodiments of the present disclosure described above.

An embodiment of the present disclosure proposes a computer program product for cross-device data transfer. The computer program product may include a computer program that is executed by at least one processor for performing any steps/processes of the method for cross-device data transfer according to embodiments of the present disclosure described above.

The embodiments of the present disclosure may be embodied in a non-transitory computer-readable medium. The non-transitory computer readable medium may include instructions that, when executed, cause one or more processors to perform any steps/processes of the method for cross-device data transfer according to embodiments of the disclosure described above.

It should be appreciated that all the operations in the methods described above are merely exemplary, and the present disclosure is not limited to any operations in the methods or orders of these operations, and should cover all other equivalents under the same or similar concepts. Additionally, the articles “a” and “an” as used in this description and appended claims, unless otherwise specified or clear from the context that they are for the singular form, should generally be interpreted as meaning “one” or “one or more.”

It should also be appreciated that all the modules in the apparatuses described above may be implemented in various approaches. These modules may be implemented as hardware, software, or a combination thereof. Moreover, any of these modules may be further functionally divided into sub-modules or combined together.

Processors have been described in connection with various apparatuses and methods. These processors may be implemented using electronic hardware, computer software, or any combination thereof. Whether such processors are implemented as hardware or software will depend upon the particular application and overall design constraints imposed on the system. By way of example, a processor, any portion of a processor, or any combination of processors presented in the present disclosure may be implemented with a micro-processor, micro-controller, digital signal processor (DSP), a field-programmable gate array (FPGA), a programmable logic device (PLD), a state machine, gated logic, discrete hardware circuits, and other suitable processing components configured to perform the various functions described in the present disclosure. The functionality of a processor, any portion of a processor, or any combination of processors presented in the present disclosure may be implemented with software being executed by a microprocessor, micro-controller, DSP, or other suitable platform.

Software shall be construed broadly to mean instructions, instruction sets, code, code segments, program code, programs, subprograms, software modules, applications, software applications, software packages, routines, subroutines, objects, threads of execution, procedures, functions, etc.

The software may reside on a computer-readable medium. A computer-readable medium may include, by way of example, memory such as a magnetic storage device (e.g., hard disk, floppy disk, magnetic strip), an optical disk, a smart card, a flash memory device, random access memory (RAM), read only memory (ROM), programmable ROM (PROM), erasable PROM (EPROM), electrically erasable PROM (EEPROM), a register, or a removable disk. Although a memory is shown as being separate from the processor in various aspects presented in this disclosure, the memory may also be internal to the processor (e.g., a cache or a register).

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein. All structural and functional equivalents to the elements of the various aspects described throughout the present disclosure that are known or later come to be known to those of ordinary skilled in the art are intended to be encompassed by the claims.

1. A method for cross-device data transfer, the method being implemented by a target application in a first terminal device, the method comprising:
identifying a trigger operation in a user interface of the target application, the trigger operation indicating to obtain target data in a second terminal device;
generating a data request in response to the trigger operation, the data request comprising a resource describing statement corresponding to the target data in the second terminal device;
sending the data request to a cross-device data transfer network unit; and
receiving a request response from the cross-device data transfer network unit, the request response comprising the target data.

2. The method of claim 1, wherein
the trigger operation comprises at least one of: designation of the second terminal device; designation of a resource directory in the second terminal device; designation of a resource in the second terminal device; and designation of a part of a resource in the second terminal device, and
the target data comprises at least one of: metadata associated with resources in a predetermined resource directory in the second terminal device; metadata associated with resources in a designated resource directory in the second terminal device; a designated resource in the second terminal device; and a designated part of a designated resource in the second terminal device.

3. The method of claim 1, wherein
the sending the data request comprises: sending the data request to the cross-device data transfer network unit through a http connection, and
the receiving a request response comprises: receiving the request response from the cross-device data transfer network unit through a http connection.

4. The method of claim 1, wherein
the resource describing statement is defined at least with an application programming interface (API) corresponding to the trigger operation.

5. A method for cross-device data transfer, the method being implemented by a cross-device data transfer network unit, the method comprising:
receiving a data request from a target application in a first terminal device, the data request comprising a resource describing statement corresponding to target data in a second terminal device;
generating a data command based on the resource describing statement;
sending the data command to a device client in the second terminal device;
receiving a command response from the device client, the command response comprising the target data; and
sending a request response to the target application in the first terminal device, the request response comprising the target data.

6. The method of claim 5, wherein the generating a data command comprises:
converting the resource describing statement into the data command according to a terminal data protocol; or
taking the resource describing statement as the data command.

7. The method of claim 5, wherein
the receiving a data request comprises: receiving the data request from the target application in the first terminal device through a http connection, and
the sending a request response comprises: sending the request response to the target application in the first terminal device through a http connection.

8. The method of claim 5, wherein
the sending the data command comprises: sending the data command to the device client in the second terminal device through a WebSocket connection established by a WebSocket server, and
the receiving a command response from the device client comprises: receiving the command response from the device client through a WebSocket connection established by the WebSocket server.

9. The method of claim 5, wherein
the resource describing statement is defined with an application programming interface (API), or defined with an API and a corresponding parameter.

10. The method of claim 9, wherein
the API is a Representation State Transfer (REST) API.

11. A method for cross-device data transfer, the method being implemented by a device client in a second terminal device, the method comprising:
receiving a data command from a cross-device data transfer network unit, the data command indicating to obtain target data in the second terminal device;
obtaining the target data based on the data command; and
sending a command response to the cross-device data transfer network unit, the command response comprising the target data.

12. The method of claim 11, wherein
the target data is a designated part of a designated resource in the second terminal device, and
the obtaining the target data comprises: extracting the designated resource from a storage unit in the second terminal device based on the data command; and extracting the designated part from the designated resource based on the data command.

13. The method of claim 11, wherein
the receiving a data command from a cross-device data transfer network unit comprises: receiving the data command from the cross-device data transfer network unit through a WebSocket connection established by a WebSocket server, and
the sending a command response to the cross-device data transfer network unit comprises: sending the command response to the cross-device data transfer network unit through a WebSocket connection established by the WebSocket server.

14. A system for cross-device data transfer, comprising a cross-device data transfer network unit and a WebSocket server, the cross-device data transfer network unit comprising a device proxy server and a connection transport server, wherein
the device proxy server is configured for: receiving a data request from a target application in a first terminal device, the data request comprising a resource describing statement corresponding to target data in a second terminal device; generating a data command based on the resource describing statement; sending the data command to the connection transport server; receiving a command response from the connection transport server, the command response comprising the target data; and sending a request response to the target application in the first terminal device, the request response comprising the target data,
the connection transport server is configured for: sending the data command received from the device proxy server to the WebSocket sever; and sending the command response received from the WebSocket server to the device proxy server, and
the WebSocket server is configured for: sending the data command received from the connection transport server to a device client in the second terminal device; and sending the command response received from the device client to the connection transport server.

15. An apparatus for cross-device data transfer, comprising:
at least one processor; and
a memory storing computer-executable instructions that, when executed, cause the at least one processor to perform operations in the method of claim 1.
